(19) United States
(12) Patent Application Publication
(10) Pub. No.: US 2011/0153055 A1
(43) Pub. Date: Jun. 23, 2011

(54) WIDE-RANGE QUICK TUNABLE TRANSISTOR MODEL

(75) Inventors: Bing J. Sheu, Hsinchu City (TW); Jiann-Tyng Tzeng, Hsiu Chu (TW); David Barry Scott, Plano, TX (US)

(73) Assignee: TAIWAN SEMICONDUCTOR MANUFACTURING CO., LTD., Hsin-Chu (TW)

(21) Appl. No.: 12/640,398

(22) Filed: Dec. 17, 2009

(51) Int. Cl. G06F 19/00; G06F 17/50

(52) U.S. Cl. 700/121; 703/14; 716/106

(57) ABSTRACT

A method includes selecting one of a plurality of existing transistor models for which fabrication and performance data are available, receiving first model data for a next-generation transistor based on target response data and the selected transistor model data, and simulating a response of a circuit including the next-generation transistor. The selection of the existing transistor model is based on target response data for the next-generation transistor for which fabrication and performance data are not available. The simulation is performed using the first transistor model data for the next-generation transistor. A difference between the target response and the simulated response of the next-generation transistor is calculated, and the first model data representing the next-generation transistor is stored in a computer readable storage medium if the performance data difference between the target response and the simulated response is below a threshold.

### FIELD OF DISCLOSURE

The disclosed systems and methods relate to the integrated circuit design. More specifically, the disclosed systems and methods relate to providing transistor modeling for new technology nodes.

### BACKGROUND

In the semiconductor manufacturing industry, circuit models are developed and simulated to determine circuit performance using computer programs. The simulations are performed to predict the performance of a circuit prior to fabricating the circuit on a semiconductor wafer. The semiconductor device models are typically based on available silicon data. For example, the Predictive Technology Model (PTM) website of Arizona State University provides a plurality of downloadable files that may be used with a wide variety of circuit simulators, e.g., a simulation program with integrated circuit emphasis (SPICE), to approximate the performance of transistors.

However, PTM models for semiconductor devices are typically only focused on the performance of a semiconductor, with little-to-no regard for the ability to manufacture the actual device. The failure to take into account manufacturing concerns results in models that have very precise tolerances and in turn require designers to make conservative, and sometimes wasteful, assumptions concerning circuit responses that may result in an unacceptably low yield. Additionally, the models are usually based on older technologies and fail to take into account the most recent advances in semiconductor manufacturing.

Accordingly, an improved system and method for predictive modeling of next generation and new technology nodes is desirable.

### SUMMARY

In some embodiments, a method includes selecting one of a plurality of existing transistor models for which fabrication and performance data are available, receiving first model data for a next-generation transistor based on target response data and the selected transistor model data, and simulating a response of a circuit including the next-generation transistor. The selection of the existing transistor model is based on target response data for the next-generation transistor for which fabrication and performance data are not available. The simulation is performed using the first transistor model data for the next-generation transistor. A difference between the target response and the simulated response of the next-generation transistor is calculated, and the first model data representing the next-generation transistor is stored in a computer readable storage medium if the performance data difference between the target response and the simulated response is below a threshold.

A system is also disclosed that includes a computer readable storage medium and a processor in signal communication with the computer readable storage medium. The computer storage medium is configured to store model data for a plurality of previously fabricated transistors. The processor is configured to receive first model data for a next-generation transistor based on target response data and model data for one of the plurality of previously fabricated transistors stored in the computer readable storage medium, simulate a response data for a circuit including the next-generation transistor, and calculate a difference between the target response data and simulated response for the next-generation transistor. The transistor model having fabrication and response data is displayed on the monitor in response to receiving target response data for the next-generation transistor for which response and fabrication data are not available. The simulation is performed using the first transistor model data for the next-generation transistor.

Another method is provided in which a plurality of transistor models of previously fabricated transistors are stored in a computer readable storage medium of an electronic design automation (EDA) tool. At least one of the plurality of transistor models is displayed on a monitor. First transistor model data for a next-generation transistor for a technology node that has not previously been fabricated is received. The first transistor model data are based on the at least one of the plurality of models disposed on the display device. A response for a circuit including the first transistor model data is simulated, and a difference between the target response data and simulated response data for the first transistor model are displayed on the monitor.

### BRIEF DESCRIPTION OF THE DRAWINGS

FIG. 1 illustrates one example of a system for generating a quick tunable transistor model.

FIG. 2 is a flow diagram of an example method of generating a quick tunable transistor model.

FIGS. 3A-3B are graphs of target performance and simulated performance of an initial transistor model.

FIGS. 4A-4D are graphs of various performance-related parameters for a target transistor and a quick tunable transistor model.

### DETAILED DESCRIPTION

The disclosed systems and methods provide transistor models that have improved accuracy for predicting circuit responses with the intended speed, active power, and leakage values as well as having improved manufacturability compared to conventional methods. These systems and methods enable the design of a circuit having a quality suitable for mass production (e.g., a V1.0 quality circuit) for next-generation technology nodes up to several years before a manufacturing process for the next-generation technology node is developed.

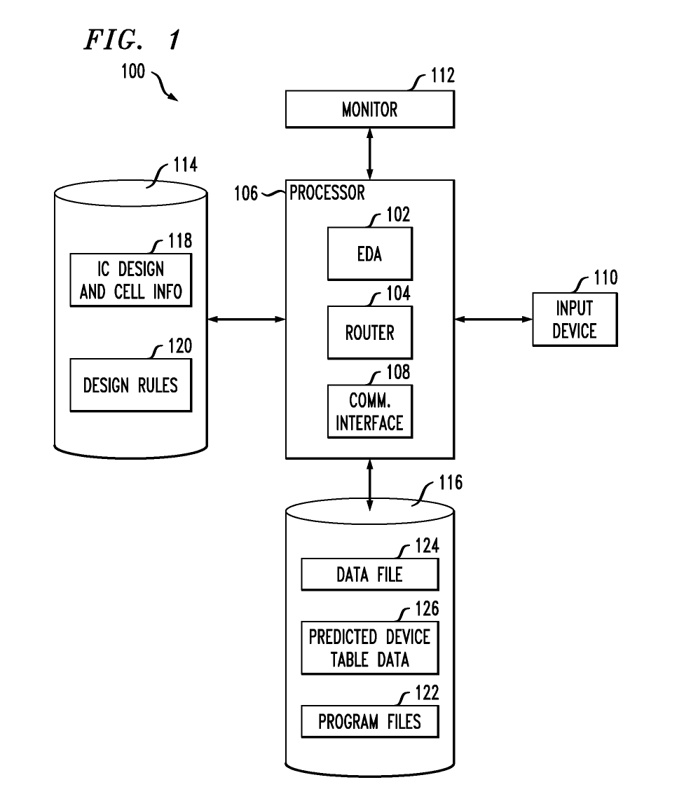

FIG. 1 is a block diagram illustrating one example of a system 100 for providing a quick tunable transistor model (QTM). As shown in FIG. 1, the system 100 may include an electronic design automation tool 102 such as “IC COMPILER”™, sold by Synopsis, Inc. of Mountain View, Calif., having a router 104 such as “ZROUTE”™, also sold by Synopsis. Other EDA tools 102 may be used, such as, for example, the “VIRTUOSO” custom design platform or the Cadence “ENCOUNTER”® digital IC design platform along with the “VIRTUOSO” chip assembly router 104, all sold by Cadence Design Systems, Inc. of San Jose, Calif.

The EDA tool 102 is a special purpose computer formed by retrieving stored program instructions 122 from a computer readable storage mediums 114, 116 and executing the instructions on a general purpose processor 106. Processor 106 may be any central processing unit (CPU), microprocessor, micro-controller, or computational device or circuit for executing instructions. Processor 106 may be configured to perform circuit simulations based on a plurality of data stored in the one or more computer readable storage mediums 114, 116.

The computer readable storage medium 114, 116 may include one or more of registers, a random access memory (RAM) and/or a more persistent memory, such as a ROM. Examples of RAM include, but are not limited to, static random-access memory (SRAM), or dynamic random-access memory (DRAM). A ROM may be implemented as a programmable read-only memory (PROM), an erasable programmable read-only memory (EPROM), an electrically erasable programmable read-only memory (EEPROM), magnetic or optical storage media, as will be understood by one skilled in the art.

System 100 may include a monitor 110 and a user interface or input device 112 such as, for example, a mouse, a touch screen, a microphone, a trackball, a keyboard, or like device through which a user may input design instructions and/or data. The one or more computer readable storage mediums 114, 116 may store data input by a user, design rules 120, IC design and cell information 118, and data files 126, such as GDSII files, representing a physical layout of a circuit. Computer readable storage mediums 114, 116 may also store predicted device target table data 126, fine tune weightings, and other transistor modeling data as described in greater detail below. Computer readable storage mediums 114, 116 may also store various transistor models in a variety of formats including, but not limited to, BSIM3, BSIM4, PSP, and HiSIM to name a few.

EDA tool 102 may include a communication interface 108 allowing software and data to be transferred between EDA tool 102 and external devices. Example communications interfaces 108 include, but are not limited to, modems, Ethernet cards, wireless network cards, Personal Computer Memory Card International Association (PCMCIA) slots and cards, or the like. Software and data transferred via communications interface 108 may be in the form of signals, which may be electronic, electromagnetic, optical, or the like that are capable of being received by communications interface 108. These signals may be provided to communications interface 108 via a communication path (e.g., channel), which may be implemented using wire, cable, fiber optics, a telephone line, a cellular link, a radio frequency (RF) link, to name a few.

The router 104 is capable of receiving an identification of a plurality of circuit components to be included in an integrated circuit (IC) layout including a list of pairs of cells, macro blocks or I/O pads within the plurality of circuit components to be connected to each other. A set of design rules 120 may be used for a variety of technology nodes (e.g., technology greater than, less than, or equal to 32 nm). In some embodiments, the design rules 120 configure the router 104 to locate connecting lines and vias on a manufacturing grid.

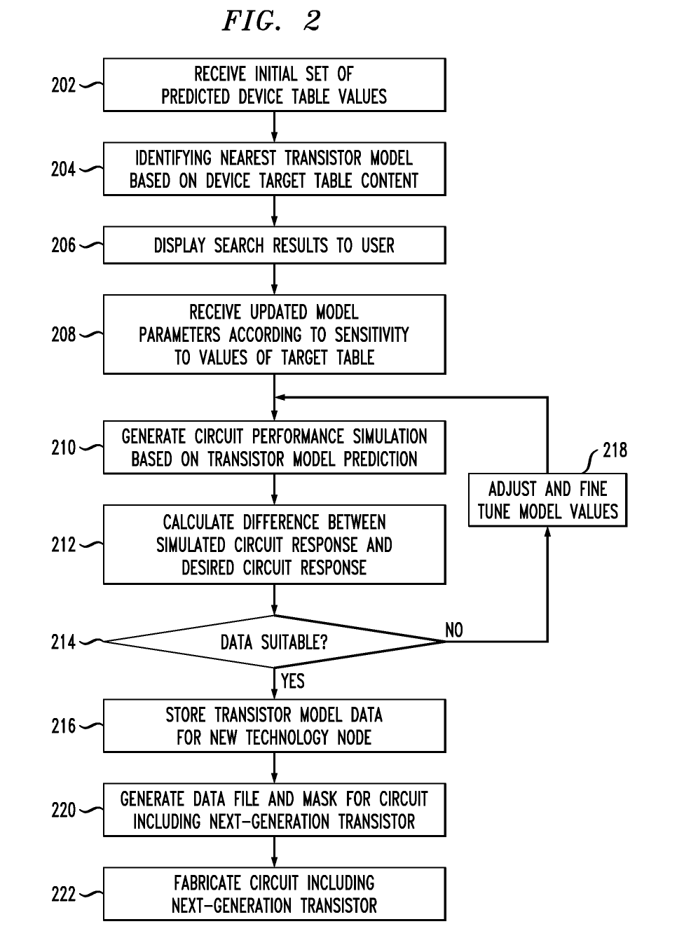

The EDA tool 102 may perform a method 200 for generating a QTM transistor model such as the one illustrated in the flow diagram shown in FIG. 2. As shown in FIG. 2, an initial set of predicted device data is received by the EDA tool 102 at block 202. The initial set of predicted device data may include target device parameters such as, for example, the turn-on voltage of the device, the operating frequency of the device, and/or the power consumption of the device. A target table for the device, which may be a next-generation transistor (i.e., a transistor for a technology node that has not previously been fabricated), based on the target device parameters may be created that sets forth various device characteristics including, but not limited to, threshold voltage of a transistor (Vₜₕ), the drain current of a transistor in the saturation region (I_{dsat}), the turnoff current (I_{off}), the drain current of the transistor in the linear region (I_{dlin}), and the operating temperature to name a few.

At block 204, a transistor model for a previously fabricated and tested transistor is identified and selected from a plurality of existing transistor models stored in a computer readable storage medium 114, 116. The identification and selection of the transistor model may be performed by the EDA tool 102 or by a user of the EDA tool 102. The selected transistor model may have response data that exactly matches or closely approximates the target response data. For example, the selected transistor model may have a leakage current or response time that matches or is close to the target leakage and response time. As will be understood by those skilled in the art, certain transistor response characteristics may be identified by a design house as being more important than other characteristics for certain circuit designs. For example, a design house may provide a low power circuit design in which power consumption is more of a priority than switching frequency. Accordingly, a transistor model having the lowest leakage value of all of the transistor models stored in a computer readable storage medium 114, 116 may be identified and selected. Alternatively, a transistor model having the lowest leakage value of the transistor models having a switching value below a certain value or within a certain range of values may be selected.

The technology node of the transistor, or other scaling indicator provided by the International Technology Roadmap for Semiconductors (ITRS) or like organization, may also be taken into account when selecting a transistor model. For example, if the target data is for an 11 nm technology node transistor, then the transistor model identified being the closest may be for a 16 nm, 22 nm, or next technology node for which there is fabrication and actual response data.

The type of transistor may also be taken into account when selecting the transistor model. For example, the computer readable storage mediums 114, 116 may store transistor models for various transistor types including, but not limited to, planar transistors, FinFET transistors, transistors formed on silicon-on-insulator (SOI) substrates, transistors with high-k and metal gates, transistors with polysilicon gates, and transistors formed on bulk substrates to name a few. Accordingly, if the model for the next-generation transistor is for a FinFET transistor, then one of the models for FinFET transistors stored in the computer readable storage mediums 114, 116 may be selected. One skilled in the art will understand that numerous other factors may also be taken into account when selecting a transistor model of a previously fabricated and tested transistor.

If the EDA system 102 performs the identification of the transistor model, then the data associated with the transistor model may be displayed on a monitor 112 to a user at block 206.

At block 208, EDA system 102 receives first model data for a next-generation transistor, which may be based on the target response data as well as the transistor model data identified at block 204. The first model data may also take into account adjustments to maximize the operating frequency of the device or to minimize the power consumption of the device. The maximization of operating frequency and/or minimization of power consumption may be based on circuit specifications received from a design house as will be understood by one skilled in the art.

At block 210, the EDA tool 102 may simulate the performance of a circuit including the first model data of the transistor. The simulation of the circuit may provide simulation data used to analyze the performance of the transistor. For example, the simulation data may be used to plot a leakage versus operating voltage (V_{dd}) curve, a frequency versus operating voltage curve, an I-V curve, a C-V, or other graphical representation of simulated data for the next-generation transistor model. The simulation data are also used to analyze the performance of the circuit. For example, if the circuit is an inverter, then the simulation data may be used to generate plots of the inverter delay versus the capacitance of the load, the inverter leakage versus the capacitance of the load, or the like. One skilled in the art will understand that a variety of simulation for a wide variety of circuits and parameters may be generated and used to analyze performance of the circuit and the transistor.

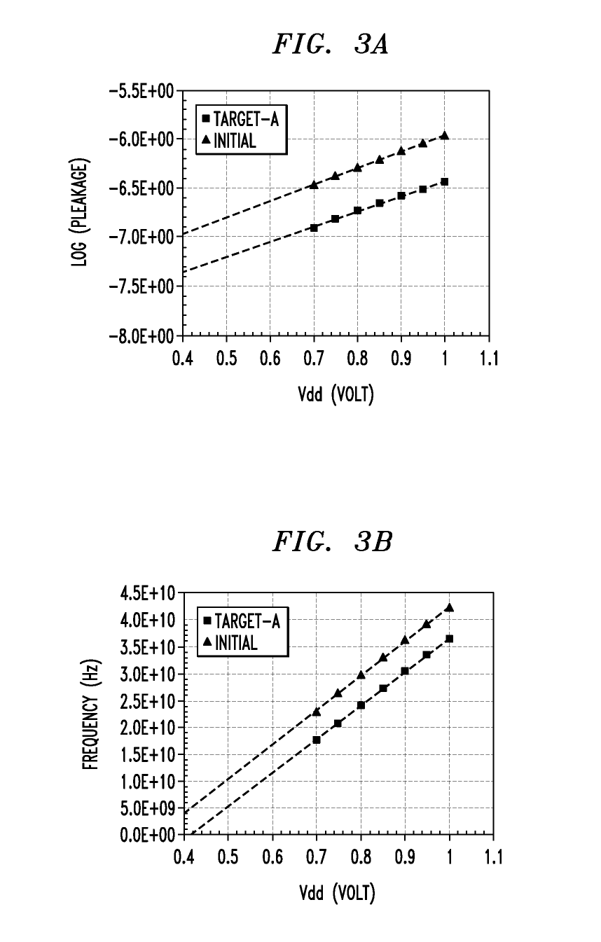

At block 212, the simulation results are used to calculate and/or identify differences between the target performance and the simulation performance of the circuit and or device. For example, FIG. 3A is an example of a graph of leakage versus supply voltage for the target performance and an initial simulation of a next-generation transistor, and FIG. 3B is a graph of frequency versus supply voltage showing the target performance and initial simulation of the next-generation transistor. As shown in FIG. 3A, the model for the next-generation transistor experiences more leakage than the it was targeted to experience. Similarly, FIG. 3B illustrates that the initial model for the next-generation transistor has a slower operating frequency than it was targeted to have.

At decision block 214, the user of the EDA tool 102, or the EDA tool 102 itself, may determine if the transistor model is acceptable or if additional tuning of the transistor model should be performed. For example, the EDA tool 102 may be configured to determine an error value of how much the simulated data differs from the desired response of the circuit and/or the next-generation transistor. If the calculated error value is outside of a predetermined threshold or range, e.g., the simulation data is not suitable for implementation, then the EDA tool 102 may continue to block 218. If the calculated error value is within a predetermined threshold or range, then the EDA tool 102 may continue to block 216.

At block 218, the calculated differences between the response of the simulation and the target response are used to guide adjustments to the first transistor model data. For example, the slope of the lines in FIG. 3A are functions of drain induced barrier lowering (DIBL) and the subthreshold swing (SS), and the slope of the lines in FIG. 3B are functions of I_{dlin}, the turn-on or threshold voltage (Vₜₕ), and the low-field charge mobility (U₀). The x-axis intercepts of the lines shown in FIG. 3B are functions of the threshold voltage measured by the transconductance method (V_{thgm}), the threshold voltage measurement by the constant current method (Vₜₗᵢₙ), and the threshold voltage measurement by the constant current method when the drain-source voltage equals the supply voltage (Vₜₛₐₜ). One skilled in the art will understand that the adjustments may be based on other relationships between manufacturing and the target performance of the transistor. For example, the long-channel threshold voltage with V_{BS} equal zero, Vₜₕ₀, may be related to other process-dependent variables according to:

Vₜₕ₀=Vₜₕ(W,L,N_{vt.imp})+ΔVₜₕ^{RSCE}(W,L,N_{vt.imp},N_{pocket.imp})+ΔVₜₕ^{NWE}(W,L,N_{vt.imp},N_{pocket.imp})

### Where,

W is the width of the channel of the transistor;

L is the length of the channel of the transistor;

N_{vt.imp} is the transistor channel implant dosage doping value; and

N_{pocket.imp} is the transistor pocket implant dosage.

Additionally, the low-field charge mobility (U₀) is a function of W, L, V_{thgm}, I_{dsat}, Nᵥₜ, and N_{pocket.imp.} and I_{dlin}. The static feedback of the transistor (Eta0) may be a function of W, L, Vₜₗᵢₙ, Vₜₛₐₜ, V_{thgm}, and the DIBL of the transistor. The turnoff voltage of a transistor (V_{off}) is a function of Vₜₗᵢₙ, Vₜₛₐₜ, and V_{thgm}. The interface trap capacitance (Cᵢₜ) is a function of W, L, Iₜₕ, SS, and the source current for turning the transistor off (I_{soff}). The saturation voltage (Vₛₐₜ) for a transistor is a function of Vₜₛₐₜ, I_{dsat}, and the effective drain current (I_{deff}).

Accordingly, if the results of the simulation differ from the target response as shown in FIG. 3B, then one or more of the physical characteristics of the transistor known to influence the x-intercept of the line, i.e., V_{thgm}, Vₜₗᵢₙ, and Vₜₛₐₜ, may be adjusted in order to adjust the response of the next-generation transistor and circuit. The adjustments may be sensitivity based adjustments as described in co-pending U.S. patent application Ser. No. 12/259,050 titled “Generating Models for Integrated Circuits with Sensitivity-Based Minimum Change to Existing Models”, which is incorporated by reference herein in its entirety. The adjustments may also take into account the ability to efficiently manufacture the semiconductor devices. For example, if the sub-threshold leakage of the device is greater than the target leakage, then the oxide thickness may be adjusted, but not to a point such that a device cannot be reliably or cost-effectively manufactured. Instead, the adjustment of the oxide thickness may be adjusted in combination with another physical parameter to achieve the desired response. Additionally, these adjustments may be based on manufacturing and silicon data as well as techniques previously acquired by a foundry for previously fabricated technology nodes. Adjusting the device parameters while taking into account the ability to manufacture the device within predefined tolerances enables a model to be developed that will yield a V1.0 product before the technique for processing the device is developed.

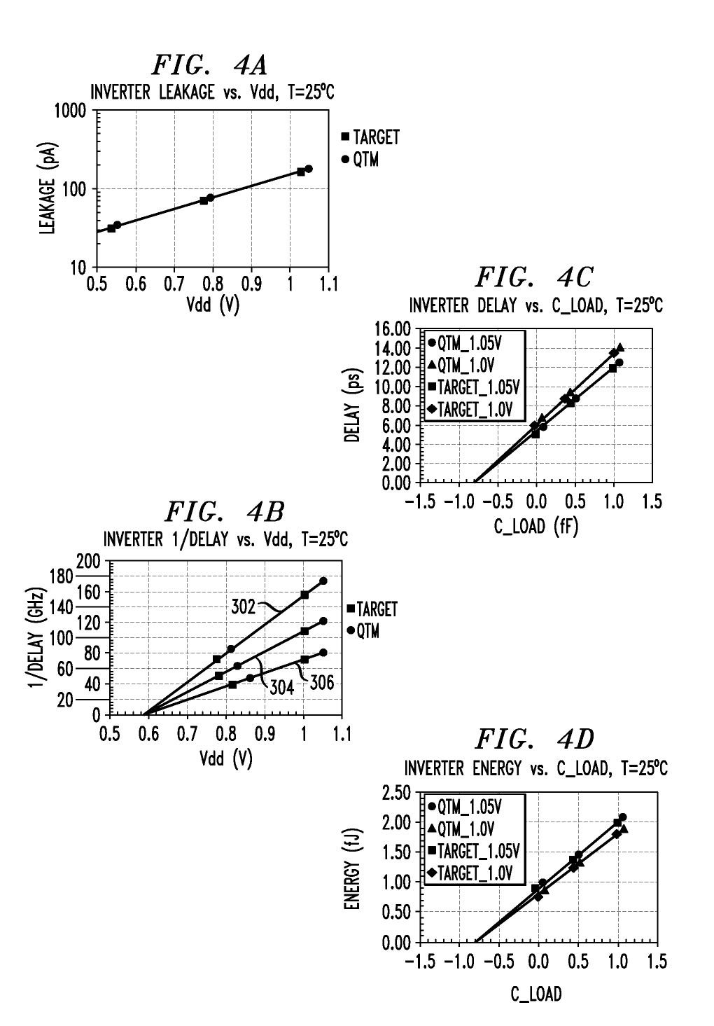

The adjusted semiconductor device parameters provide second model device data, which may be used to simulate the circuit performance at block 210. Accordingly, blocks 208, 210, 212, 214, and 218 may be repeated until the simulated circuit performance including the next-generation transistor is sufficiently close to the target response. For example, FIGS. 4A-4G illustrate various graphs of showing the performance of an inverter circuit including a QTM transistor that is sufficiently close to the target performance for an 32 nm inverter circuit using low-power, high-k metal gate transistors. FIG. 4A is a graph of inverter leakage versus operating voltage for the target performance and the simulated performance of a device simulated using a QTM transistor, and FIG. 4B is a graph of frequency delay versus operating voltage showing the target performance and the simulated performance of a QTM transistor (line 302), an inverter including a QTM transistor (line 304), and a QTM transistor with a 1 fF capacitor coupled to the QTM transistor (line 306). As shown in FIGS. 4A and 4B, the simulated responses of the inverter, the QTM transistor, and the QTM transistor with the capacitor are almost identical the to target responses.

FIG. 4C is a graph of inverter delay versus the capacitance of the load for an inverter having an operating voltage of 1.05 volts and 1 volt, and FIG. 4D is a graph of inverter energy versus the capacitance of the load for the inverter having an operating voltage of 1.05 volts and 1 volt. As shown in FIGS. 4C and 4D, the simulated response of the inverter including the QTM transistor has an almost identical response to the target response.

When the desired circuit performance is achieved, e.g., the differences between the simulated results and the target results are within a predetermined range, then the transistor model data may be stored in a computer readable storage medium 114, 116 at block 216.

At block 220, a data file, such as a GDSII file, including data representing a physical layout of a circuit including the next-generation transistor, may be generated and stored in a computer readable storage medium 114, 116. The data file may be used by mask making equipment, such as an optical pattern generator, to generate one or more masks for the circuit including the next-generation transistor.

At block 222, the router 104 may fabricate the circuit including the next-generation transistor when the process for the technology node is developed as will be understood by one skilled in the art.

The proposed method 200 for generating a QTM may be used to generate transistor models for planar devices such as NMOS and PMOS as well as to generate transistor models for FinFET devices. Advantageously, these transistor models may be generated before the manufacturing process for these devices is developed while retaining maximum manufacturability for device physics in the newly generated transistor model. Developing the transistor models in accordance with the method 200 described above enables the creation of transistor models based on physically meaningful interrelationships among device parameters. Advantageously, the QTM transistor models enable foundries and design houses to address circuit fabrication and design issues such as V_{dd}/V_{thgm} headroom and performance at constant power density issues as well as to perform and corner/variability assessments before a circuit is fabricated.

The present invention may be at least partially embodied in the form of computer-implemented processes and apparatus for practicing those processes. The present invention may also be at least partially embodied in the form of computer program code embodied in tangible machine readable storage media, such as random access memory (RAM), read only memories (ROMs), CD-ROMs, DVD-ROMs, BD-ROMs, hard disk drives, flash memories, or any other machine-readable storage medium, wherein, when the computer program code is loaded into and executed by a computer, the computer becomes an apparatus for practicing the invention. The present invention may be embodied at least partially in the form of computer program code, whether loaded into and/or executed by a computer, such that, when the computer program code is loaded into and executed by a computer, the computer becomes an apparatus for practicing the invention. When implemented on a general-purpose processor, the computer program code segments configure the processor to create specific logic circuits. The invention may alternatively be at least partially embodied in a digital signal processor formed of application specific integrated circuits for performing a method according to the principles of the invention.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method, comprising:
(a) selecting one of a plurality of existing transistor models for which fabrication and performance data are available, the selection based on target response data for a next-generation transistor for which fabrication and performance data are not available;
(b) receiving first model data for the next-generation transistor based on the target response data and the selected transistor model data;
(c) simulating a response of a circuit including the next-generation transistor, the simulation performed by a processor using the first transistor model data for the next-generation transistor;
(d) calculating a difference between the target response and the simulated response of the next-generation transistor; and
(e) storing the first model data representing the next-generation transistor in a computer readable storage medium if the performance data difference between the target response and the simulated response is below a threshold.

2. The method of claim 1, wherein the first model data for the next-generation transistor is received at an electronic design automation (EDA) tool.

3. The method of claim 1, further comprising:
(f) receiving second model data for the next-generation transistor based on the first model data and the difference between the target response data and the simulated response data if the difference between the target response data and the simulated data exceeds the threshold; and
(g) repeating steps (c), (d), and (e) using the second transistor model data in place of the first transistor model data.

4. The method of claim 3, wherein the second model data includes at least one difference from the first model data, and wherein the at least one difference is based on the simulation of the first model data and fabrication data for one of the plurality of existing transistor models for which fabrication and performance data are available.

5. The method of claim 1, wherein the next-generation transistor is for a technology node that has not previously been fabricated.

6. The method of claim 1, wherein the target response data includes at least one transistor response parameter selected from the group consisting of operating voltage, response time, and power consumption.

7. The method of claim 1, wherein the transistor model data includes at least one parameter selected from the group consisting of a channel width, a channel length, and an oxide thickness.

8. The method of claim 1, wherein a technology node of the selected transistor model is a previous technology node to a technology node of the next-generation transistor.

9. The method of claim 1, further comprising
generating a GDSII file for the circuit including the next-generation transistor based on the model data for the next-generation transistor; and
manufacturing the circuit including the next-generation transistor based on the model data for the next-generation transistor.

10. A system, comprising:
a computer readable storage medium configured to store model data for a plurality of previously fabricated transistors; and
a processor in signal communication with the computer readable storage medium, the processor configured to:
receive first model data for the next-generation transistor based on target response data and model data for one of the plurality of previously fabricated transistors stored in the computer readable storage medium;
simulate a response for a circuit including the next-generation transistor, the simulation performed using the first transistor model data for the next-generation transistor; and
calculate a difference between the target response data and simulated response for the next-generation transistor.

11. The system of claim 10, wherein the processor is configured to:
receive second model data for the next-generation transistor, the second model data based on the first model data and the difference between the target response data and the simulated response data;
simulate a response for a circuit including the next-generation transistor, the simulation performed using the second transistor model data; and
calculate a difference between the target response data and simulated response data for the second transistor model.

12. The system of claim 10, wherein the second model data includes at least one difference from the first model data, and wherein the at least one difference is based on the simulation of the first model data and fabrication data for one of the plurality of existing transistor models for which fabrication and performance data are available.

13. The system of claim 10, wherein the target response data is for a technology node that has not previously been fabricated.

14. The system of claim 10, wherein the target response data includes at least one transistor response parameter selected from the group consisting of operating voltage, response time, and power consumption.

15. The system of claim 10, wherein the transistor model data includes at least one parameter selected from the group consisting of a channel width, a channel length, and an oxide thickness.

16. A method, comprising:
(a) storing a plurality of transistor models of previously fabricated transistors in a computer readable storage medium of an electronic design automation (EDA) tool;
(b) displaying at least one of the plurality of transistor models on a display;
(c) receiving first transistor model data for a next-generation transistor for a technology node that has not previously been fabricated, the first transistor model data based on the at least one of the plurality of models disposed on the display;
(d) simulating a response for a circuit including the first transistor model data; and
(e) graphically displaying a difference between the target response data and simulated response data for the first transistor model on the display.

17. The method of claim 16, further comprising:
generating a mask for a circuit including the next-generation transistor; and
fabricating the circuit including the next-generation transistor.

18. The method of claim 16, further comprising:
(f) receiving second model data for the transistor that has not previously been fabricated, the second model data based on the first model data and the difference between the target response data and the simulated response data; and
(g) repeating steps (c), (d), and (e) using the second transistor model data in place of the first transistor model data.

19. The method of claim 18, wherein steps (f) and (g) are performed if the difference between the target response data and the simulated response data exceeds a threshold value.

20. The method of claim 18, wherein the second model data includes at least one difference from the first model data, and wherein the at least one difference is based on the simulation of the first model data and fabrication data for one of the plurality of existing transistor models for which fabrication and performance data are available.

21. The method of claim 18, wherein the target response data includes at least one transistor response parameter selected from the group consisting of operating voltage, response time, and power consumption.
